(19) United States
(12) Patent Application Publication
(10) Pub. No.: US 2024/0109714 A1
(43) Pub. Date: Apr. 4, 2024

(54) Aerosol Spray Guide

(71) Applicants: Joi Sumpton, Dunwoody, GA (US); Paul Sumpton, Dunwoody, GA (US)

(72) Inventors: Joi Sumpton, Dunwoody, GA (US); Paul Sumpton, Dunwoody, GA (US)

(21) Appl. No.: 18/538,341

(22) Filed: Dec. 13, 2023

Related U.S. Application Data
(63) Continuation-in-part of application No. 29/806,711, filed on Sep. 6, 2021.

(51) Int. Cl. B65D 83/20; A01M 1/20; B65D 83/30

(52) U.S. Cl. CPC B65D 83/205; A01M 1/2038; B65D 83/30

(57) ABSTRACT

An aerosol spray guide for an insecticide repellant dispensed from an aerosol can having an interior housing said insecticide repellant and an actuator having an opening for dispensing the insecticide repellant from the interior housing when actuated. The aerosol spray guide includes an aerosol cap mount having an aerosol cap mount interior for receiving an aerosol cap of the insecticide repellant. The aerosol cap mount adapted for fixedly attachment to the aerosol can or cap such that the aerosol cap mount may be securely affixed to the aerosol can or cap wherein maneuverability of the aerosol can result in movement of said aerosol cap mount. The aerosol cap mount defines an aerosol actuator opening permitting access to the actuator from an individual.

### PRIORITY CLAIM

This application claims is a continuation in part of United States Design Patent Application having Ser. No. 29/806,711 filed on Sep. 6, 2021, entitled Aerosol spray guide and claims priority of the entire document. The full description and drawings of this application are hereby incorporated by reference in its entirety.

### TECHNOLOGICAL FIELD

The present invention relates to a spray guide for aerosol use, and more particularly, to a directional spray guide for spraying an aerosol which includes an agent and propellant to maximize the spraying effect of the agent in a targeted area.

### BACKGROUND

Utilization of aerosol sprays utilizing a propellant is a common way to apply an agent for a particular task. Aerosol sprays and propellants are utilized for painting, applying pesticides, and insecticides among other applications. During each of these applications, the aerosol spray typically exits an aerosol spray from a nozzle in a pattern which fans out from a stream to a dispersed zone significantly wider than the original stream. A problem which such utilization is that the dispersed spray may be wider than the intended target causing an overlap of the application of the agent to the desired area.

For instance, when applying paint, the spray paint may project onto an area wider than the intended target thus creating an undesired mess. Additionally, since spray applications are typically required to be conducted in ventilated areas, the airflow may transport the aerosol spray to unintended areas also creating a mess. This situation also arises when spraying a pesticide or weed killer onto a weed or the like. As this is done outdoors, the pesticide maybe transported by the wind onto a nearby plant, thus subjecting the desired plant with weed killer poison and potentially damaging the non-weed plant.

Repelling insects is a frequent task in households and other areas. Typically when encountering an insect, an insecticide pesticide in an aerosol condition contained within a spray dispenser is dispensed towards the insect. The cloud is typically projected in an untargeted shotgun format towards the intended target. Such random dispersion is not always effective in that the insect may only marginally be impacted by the pesticide while a large area devoid of insects receives a large proportion of the dispersed insecticide. This shotgun approach is a waste of the pesticide and the overall efficiency and effectiveness is lacking. Furthermore, the fumes from the pesticide permeate through the air and may subsequently be inhaled by a human. A more dire situation arises in that while the insect may have been impacted by the pesticide, typically there is a time lapse wherein the insect is immobilized allowing the insect to scatter away from the targeted area in a flight mode thereby either dying and decaying at an unknown area leaving an untidy home or successfully surviving the spray encounter.

Certain attempts to provide spray guides have been developed. However, while suited for their intended purpose, they typically are unwieldly and not sufficiently designed for effective and rapid deployment.

Accordingly, it is an object of the present invention to provide an insecticide sprayer which is suitable for targeting insects at multiple distances and which may be easily maneuverable by the user utilizing the aerosol insecticide.

### SUMMARY OF THE INVENTION

An aerosol spray guide for an insecticide repellant dispensed from an aerosol can having an interior housing said insecticide repellant and an actuator having an opening for dispensing the insecticide repellant from the interior housing when actuated. The aerosol spray guide includes an aerosol cap mount having an aerosol cap mount interior for receiving an aerosol cap of the insecticide repellant. The aerosol cap mount adapted for fixedly attachment to the aerosol can or cap such that the aerosol cap mount may be securely affixed to the aerosol can or cap wherein maneuverability of the aerosol can result in movement of said aerosol cap mount. The aerosol cap mount defines an aerosol actuator opening permitting access to the actuator from an individual. The spray guide director defines an aerosol passageway extending from a proximal end carried by the aerosol cap mount and a distal end oppositely disposed from the aerosol cap mount. The proximal end defining a spray guide entrance way for receiving an aerosol dispensed from the aerosol can and the distal end defining a spray guide exit having a predetermined circumference for dispensing the aerosol away from the spray guide director. The spray guide director directing the flow of the dispensed aerosol from the spray guide entrance way to the spray guide exit for directing the aerosol to a target located within the circumferential profile of the spray guide exit. The spray guide director being maneuverable by movement of the aerosol dispenser.

### DESCRIPTION OF THE DRAWINGS

FIG. 1 is a side perspective view of the present invention illustrating an aerosol spray guide for utilization with an aerosol container housing an agent;

FIG. 2 is a bottom perspective view of the present invention illustrating an aerosol spray guide for utilization with an aerosol container housing an agent;

FIG. 3 is a front view of the present invention illustrating the open dispersion end of an aerosol spray guide and the interior for dispersion of an agent;

FIG. 4 is a rear view of the present invention illustrating the user end of an aerosol spray guide;

FIG. 5 illustrates a side view of an aerosol spray guide according to the present invention;

FIG. 6 illustrates a top view of an aerosol spray guide according to the present invention;

FIG. 7 illustrates a bottom view of an aerosol spray guide according to the present invention;

FIG. 8 illustrates an aerosol spray guide according to the present invention deployed with a spray canister for utilization in spraying the agent onto a target;

FIG. 9 illustrates an aerosol spray guide according to the present invention as used by an individual;

FIG. 10 illustrates the interior an aerosol spray guide with a spray canister attached;

### DETAILED DESCRIPTION

Novel features of the invention will be better understood from the following description considered in connection with the accompanying drawings, in which preferred embodiments of the invention are illustrated by way of example. It is to be understood, however, that the drawings are for illustration description only and are not intended as definitions of the limits of the invention. The various features of novelty which characterize the invention are recited with particularity in the claims.

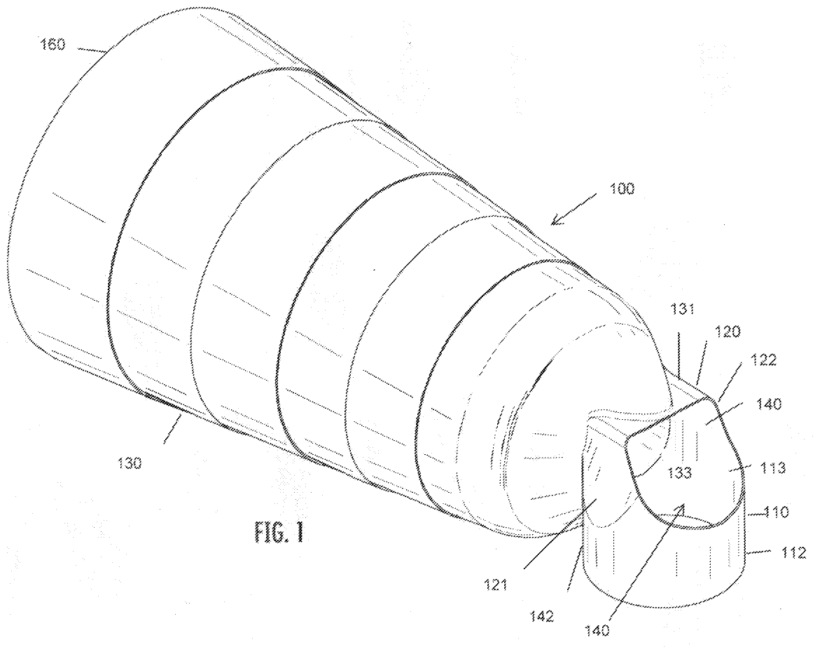

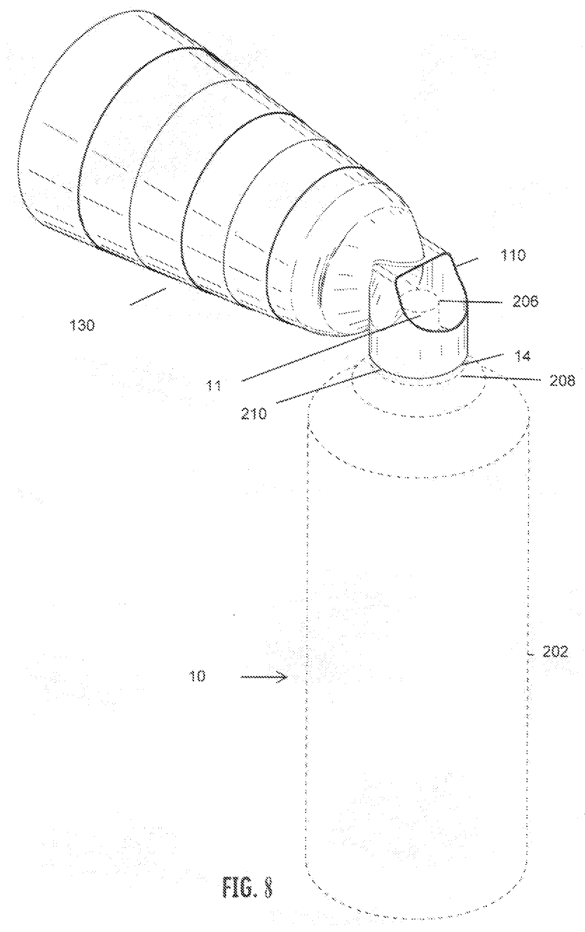

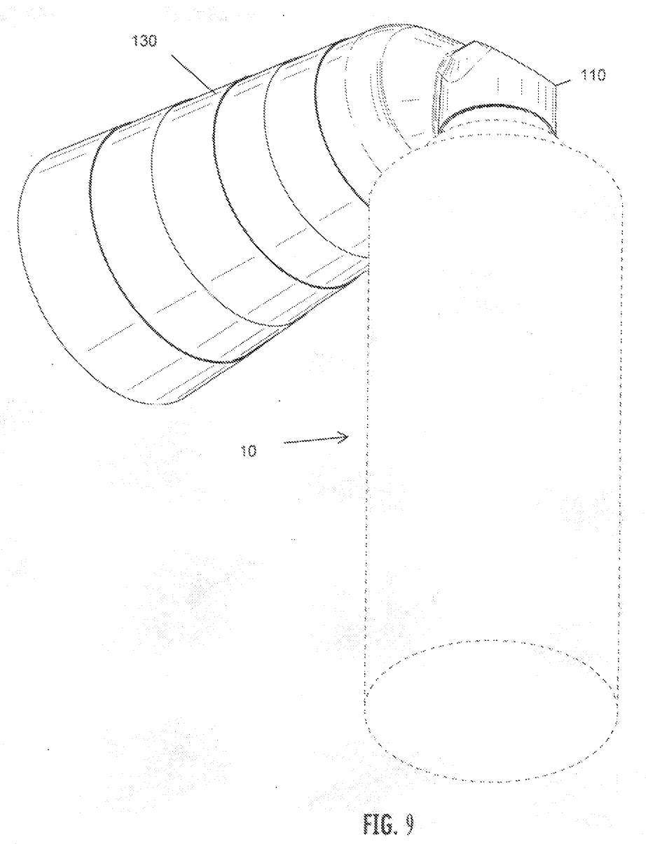

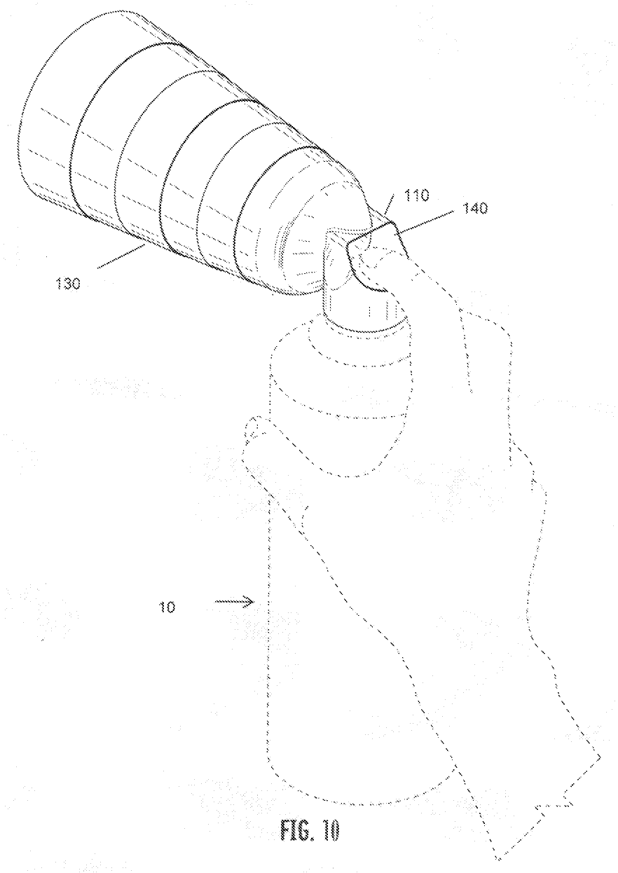

Turning to FIGS. 1, 8, 9, and 10, the aerosol spray guide is adapted for utilization with an aerosol spray device 10 containing an agent. The agent may be paint, insecticide, pesticide or any agent carried by a propellant. For particular discussion of the preferred embodiment, but not limiting, the aerosol spray device may be an aerosol can under the trademark such as Raid® which is well known and includes an aerosol containing an insecticide housed within the interior of the spray device. The spray device includes an actuator 11 which when depressed releases the aerosol from the interior of the can in a pressurized spray through an opening in communication with the interior of the spray device such as a nozzle. Generally the actuator includes a depressible plunger which is biased in position preventing the aerosol from being dispersed. When depressed the aerosol is released.

The aerosol spray device 10 preferably is constructed to include a primary aluminum cylindrical body 202 for housing the aerosol which preferably is an insecticide. The aerosol spray device contains a closed bottom and a dispensing tube assembly wherein when the dispensing tube is depressed the pressurized contents of the interior of the aerosol spray device is permitted to escape through the dispensing tube to the ambient environment. The aerosol spray device includes actuator 21 which communicates with the dispensing tube. Typically the actuator includes a spray nozzle 206 with an opening and a centralized internal channel which when depressed downward, enables the internal aerosol to be dispensed from the dispensing tube through the centralized internal channel of the actuator and through the spray nozzle. A cap 14 carries the actuator which is presented to the ambient environment enabling an end user to activate the actuator. The cap is generally made from a hard plastic and is secured to the aerosol spray device. The cap includes a cap bottom which abuts with a collar of the aerosol spray body wherein the circumferential bottom edge of the cap bottom forms a rim 208 which is offset from the aerosol spray body forming a cap gap 210.

As shown in FIG. 1, the present invention includes a spray guide 100 for directing the dispensed aerosol emitted from the spray can outlet or spray nozzle 206. The present invention has been proposed in order to solve the above-mentioned problems in the prior art, and it is intended to provide an agent in a manner which results in minimizing the amount of agent emitted from the can by providing a specific desired target area and preventing a percentage of the agent to be carried away from the intended target due to airflow. With reference to the use of an insecticide, the provision of a specific target area also increases the effectiveness of the agent by directing the agent specifically to the intended target and maintaining the intended target within the spray thereby increasing the time of exposure of the intended target with the insecticide thereby increasing the effectiveness due to the increased time of exposure of the insect with the insecticide. Namely, the insect cannot run away when sprayed and thereby only be exposed to an inconsequential amount of insecticide which may happen to actually contact the insect. Instead, the intended targeted insect is maintained within the insecticide cloud of the aerosol which is maintained within the confines of the spray guide and is constantly exposed to the chemicals while trapped within the confines of the spray guide. In this embodiment, the spray guide acts as both a spray guide and also an insect trap.

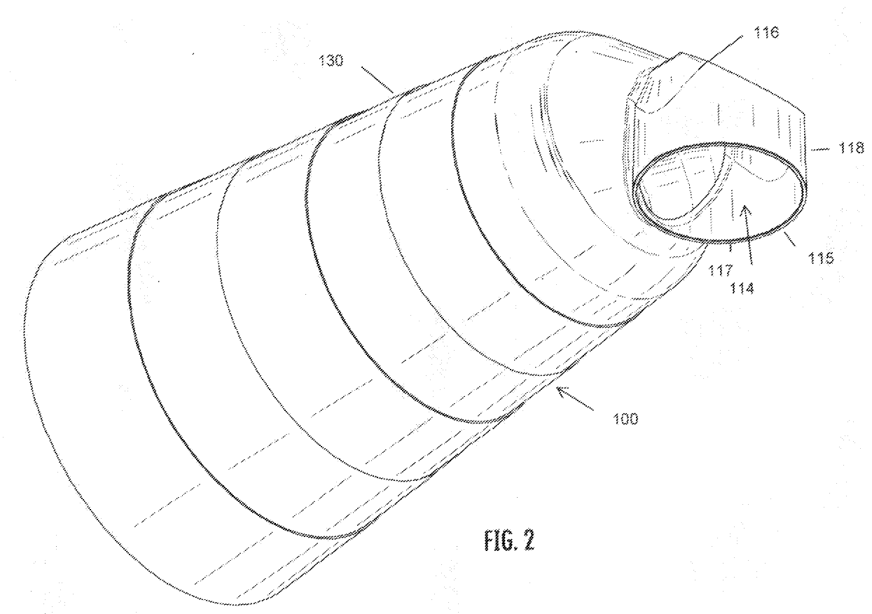

As shown in FIGS. 1 and 2, the spray guide 100 includes an aerosol cap mount 110, an elongated spray guide director 130 and a spray guide neck 120 for connecting the spray guide director 130 with aerosol cap mount 110. Aerosol cap mount 110 is an important part of the invention as it supports the spray guide director when the spray guide is attached to the aerosol cap. Aerosol cap mount 110 includes a generally cylindrical body 112 having an aerosol cap mount interior 113 which is preferably cylindrical for receiving the aerosol cap of the aerosol can. Aerosol cap mount 110 preferably fully receives the aerosol cap within the cylindrical interior 113. Aerosol cap mount 110 includes a lower rim 115 defining an aerosol cap opening 114 enabling the aerosol cap to be inserted from beneath the spray guide 100 into the aerosol cap mount interior. The aerosol cap mount has a left side 116 and a right side 118 of a general height which is taller than the height of an aerosol cap. This height enables the aerosol cap mount to fully receive the aerosol cap mount while also providing structural support for the elongated spray guide director to maintain the elongated spray guide director in a general horizontal position when the spray guide 100 is mounted onto an aerosol spray.

As shown in the Figures, the aerosol cap mount preferably includes a cylindrical cap mating portion which includes a cylindrical shell forming a hollow cylindrical interior for receiving the cylindrical body of the aerosol insecticide can. The cylindrical shell is designed to snap over the cap of the aerosol can and encircle the cap by receiving the cylindrical cap in the interior of the cylindrical shell. The cylindrical shell includes an upper roof portion which has a top which has a horizontal cap mount roof 131 which forms an upper portion of spray guide neck 120, a left and right spray guide neck sidewall 121 and 122 respectfully which rise from the lower portion or rim of the aerosol cap mount. The cylindrical cap is designed for rigid mating attachment to the aerosol can. In one embodiment, the cylindrical cap rim includes a ridge which protrudes generally horizontally towards the interior of the cylindrical cap from the exterior wall of the cylindrical cap. This ridge is designed to be aligned with the aerosol cap gap which exists in the aerosol can between the body of the can and the upper spray nozzle mechanism or top. The ridge snaps into the gap maintaining the cylindrical cap and consequently the spray guide. An additional attachment may include a flexible member carried by the interior of the cylindrical cap mating portion which may be an O-ring, a gasket or the like which may compress into the aerosol cap gap.

A key feature of the invention is the ability of the insecticide spray guide to be carried by and manipulated into position via the handling of the aerosol can. The rigid structure of the body coupled with the secure mating attachment enables the body to act as an extension of the aerosol can such that the end user may direct the spray of the aerosol can to a specific target and the aerosol spray guide maintains a constant orientation with respect to the nozzle outlet and the dispersion of the atomized agent.

As shown in the Figures, aerosol cap mount 110 includes an aerosol actuator opening 140 which is aligned with the actuator of the aerosol spray enabling an individual to have access to the actuator for actuating the actuator and subsequently dispensing the aerosol.

Typically, the nozzle construction of an aerosol dispenser dispenses the atomized aerosol in a conical stream with a thin stream emitted directly from the nozzle which expands outward as the stream travels away from the nozzle outlet. One skilled in the art is aware of the varying nozzles which produce this result. To accommodate this spray pattern, the aerosol spray guide has a corresponding flared shape with the distal dispensing end of the spray guide having a larger diameter than the proximate end carried by the aerosol can. This structure enables the lateral spread of the aerosol spray from being impeded wherein the aerosol insecticide would impact the sides of the spray guide if the spray guide was too narrow. Hence, in this manner the conical shape of the aerosol spray guide generally mimics the shape of the spray. Additionally this shape construction is an effective design. If the spray guide was of a constant diameter narrower than the conical spray pattern which would normally be dispensed, then the spray pattern would be impeded and a certain amount of aerosol would engage the sidewalls of the spray guide and stay within the interior of the spray guide and not be dispensed for killing the respective insect. Additionally, if the spray guide was of the same maximum diameter as the final spray pattern of the aerosol spray, then the guide would be to cumbersome and heavy for easy manipulation by the end user moving the aerosol spray can. Hence, the conical shape of the aerosol spray guide does not impede the flow of the aerosol spray, but also provides for a center of gravity which enables maneuverability of the aerosol spray guide to be easily manipulated by movement of the aerosol can.

FIG. 2 is a bottom perspective view of the present invention illustrating an aerosol spray guide for utilization with an aerosol container housing an agent. As shown in FIG. 2, the bottom of the cap mount is open defining aerosol cap opening 114 as defined by the periphery of lower rim 115 which includes attachment member 117 which may be an extending rib which will subsequently mate with the rim of the aerosol can fixedly attaching the spray guide 100 to the aerosol can. A spray guide director channel opening 142 communicates the interior of the spray guide director with the interior of the aerosol cap mount via the interior of the respective spray guide neck sidewalls enabling the aerosol dispensed from the nozzle to communicate into the interior of the spray guide and ultimately for dispersion via the exit opening 160 of the spray guide.

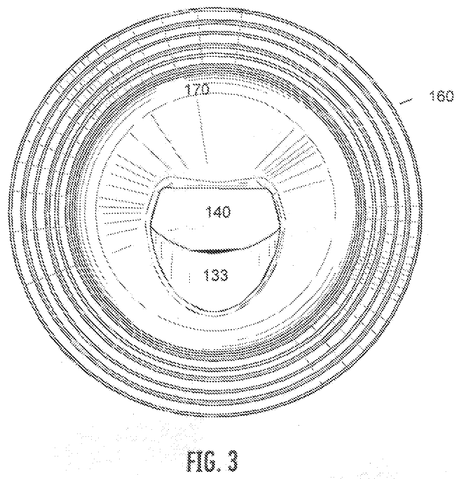

FIG. 3 is a front view of the present invention illustrating the open dispersion end of an aerosol spray guide and the interior for dispersion of an agent. As shown in FIG. 3, the interior 170 of spray guide director 130 extends continuously from the proximate end of the spray guide director 130 at spray guide director exit 160 to aerosol cap mount 110 which includes aerosol cap mount front wall 133 which in combination with the respective side walls and rear wall defines aerosol cap mount 110. The aerosol cap mount front wall extends upward from the bottom of the aerosol cap mount to a height which extends higher than the interior 170 of spray guide director 130. Aerosol cap mount front wall provides structural integrity to the aerosol cap mount which enables the aerosol cap mount to cooperate with the aerosol can enabling a user to manipulate the positioning of the end of the spray guide director by solely manipulating the aerosol can. This is important when the spray guide director is positioned in an upright manner against the ceiling or at an elevated height along a wall. A flimsy structure will not enable the exit of the spray guide director to be sufficiently positioned in such a manner

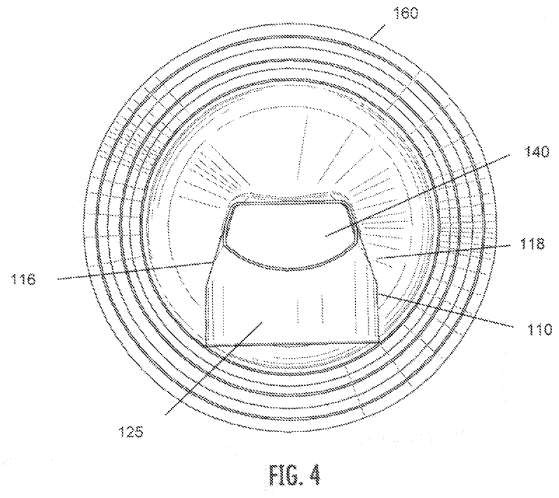

FIG. 4 is a rear view of the present invention illustrating the user end of an aerosol spray guide. This view illustrates the aerosol cap mount 110 with the sidewalls 116 and 118 and back wall 125. The combination of the sidewalls back wall and front wall preferably define a contiguous aerosol cap mount for enclosing the actuator of the aerosol spray can and providing a three hundred and sixty degree surface for fixedly attaching to the aerosol spray can. This full contact between the aerosol cap mount and the aerosol spray can provides for a solid morphing between the two bodies such that the spray guide is rigidly adhered to the aerosol spray can facilitating in the ease of manipulating the spray guide by moving the aerosol spray can. Aerosol actuator opening 140 is defined by the respective sidewalls and backwall.

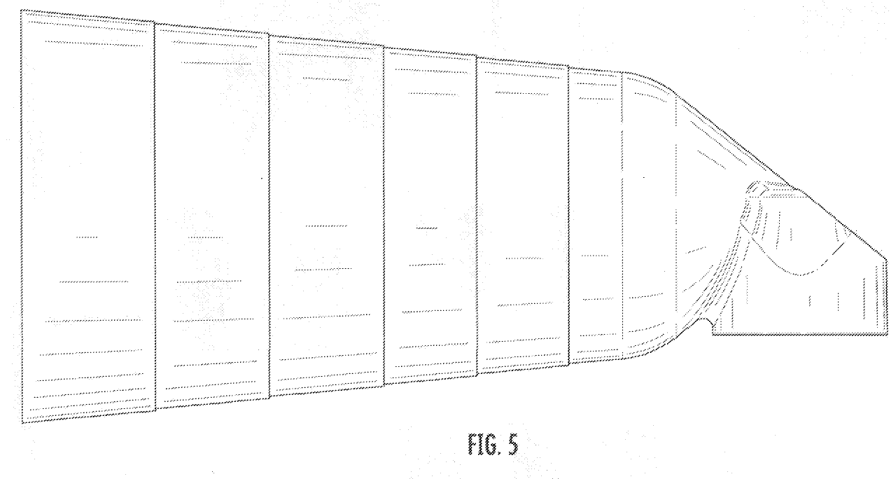

FIG. 5 illustrates a side view of an aerosol spray guide according to the present invention illustrating the continuous body of the spray guide which includes the aerosol cap mount molded into a solid rigid construction from one end of the spray guide to the other for receiving the aerosol spray can. The flaring profile of the spray guide is shown.

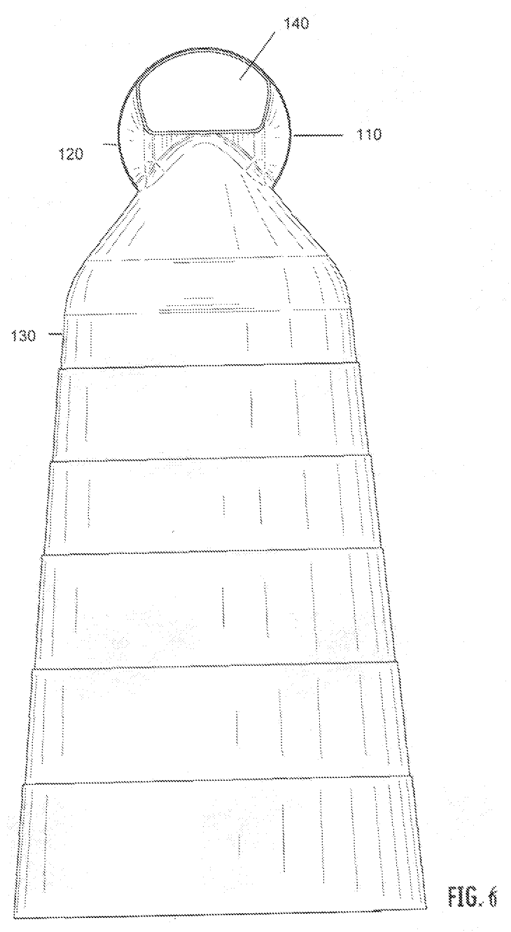

FIG. 6 illustrates a top view of an aerosol spray guide according to the present invention. The aerosol cap mount 110 has a circular profile for receiving the cylindrical profile of an aerosol dispenser. Spray guide neck 120 integrates the aerosol cap mount 110 with the spray guide director 130. The aerosol actuator opening 140 is open to the ambient environment providing access to an aerosol spray actuator.

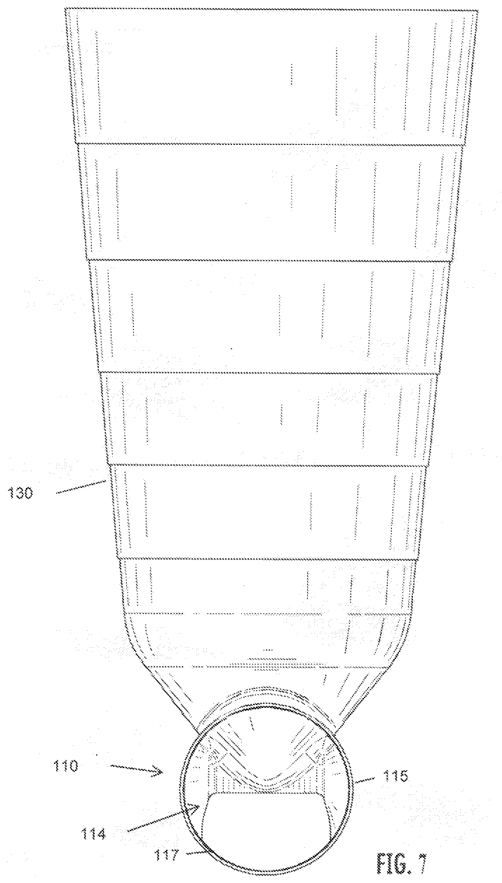

FIG. 7 illustrates a bottom view of an aerosol spray guide according to the present invention. Aerosol cap mount 110 includes a lower rim 115 defining an aerosol cap opening 114 enabling the aerosol cap to be inserted from beneath the spray guide 100 into the aerosol cap mount interior. The lower rim 115 carries attachment member 117 for rigidly attaching to an aerosol can. In one embodiment, attachment member 117 is preferably an extending rib which fits within the gap of an aerosol spray can aluminum body and plastic cap. Attachment member 117 may also be a deformable or compressible ring which frictionally secures the aerosol cap mount to the body of the aerosol can by compressing when the aerosol can body is inserted into the interior of the aerosol cap mount.

In operation it may be seen that an advantageous solution to controlling insects may be had according to the present invention. When an undesired insect is discovered, the user may rapidly attach the aerosol spray guide onto an aerosol can by snapping the spray guide onto the aerosol cap or can. The user can then entrap the insect by positioning the circumferential exit of the spray guide around the insect entrapping the insect within the confines of the spray guide. The user can then dispense the insecticide which is also contained within the profile of the spray guide such that the insect is immersed in the insecticide. The rigid construction of the spray guide enables the user to position the spray guide onto a wall or ceiling in either horizontal or vertical position merely by manipulating the positioning of the aerosol can. In essence the spray guide becomes an extension of the aerosol can.

We claim:

1. An aerosol spray guide for an insecticide repellant dispensed from an aerosol can having an interior housing said insecticide repellant and an actuator having an opening for dispensing said insecticide repellant from said interior housing when actuated, said aerosol spray guide, the aerosol can having an aerosol cap carrying the actuator, said aerosol spray guide comprising:
an aerosol cap mount having an aerosol cap mount interior for receiving an aerosol cap;
said aerosol cap mount adapted for fixedly attachment to the aerosol can or cap such that said aerosol cap mount may be securely affixed to the aerosol can or cap wherein maneuverability of the aerosol can results in movement of said aerosol cap mount;
said aerosol cap mount defining an aerosol actuator opening permitting access to the actuator from an individual;
a spray guide director defining an aerosol passageway extending from a proximal end carried by said aerosol cap mount and a distal end oppositely disposed from said aerosol cap mount;
said proximal end defining a spray guide entrance way for receiving an aerosol dispensed from said aerosol can and said distal end defining a spray guide exit having a predetermined circumference for dispensing the aerosol away from the spray guide director;
said spray guide director directing the flow of the dispensed aerosol from the spray guide entrance way to said spray guide exit for directing the aerosol to a target located within the circumferential profile of the spray guide exit; and
said spray guide director being maneuverable by movement of the aerosol dispenser.

2. The spray guide of claim 1 wherein said aerosol cap mount includes a left and right side of a general height which is taller than the height of the aerosol cap when the aerosol cap is received within the aerosol cap mount.

3. The spray guide of claim 1 wherein said aerosol cap mount includes a lower rim defining an aerosol cap opening enabling an aerosol cap to be inserted from beneath the aerosol cap mount into the aerosol cap mount interior.

4. The spray guide of claim 1 wherein said aerosol cap mount includes a cylindrical cap mating portion which includes a cylindrical shell forming a hollow cylindrical interior for receiving a cylindrical body of an aerosol cap; said cylindrical shell being designed to snap over a cap of an aerosol can and encircle the cap by receiving the cylindrical cap in the interior of the cylindrical shell.

5. The spray guide of claim 4 wherein said cylindrical shell includes an upper roof portion and a left and right spray guide neck sidewall. Said spray guide director extending from said sidewalls.

6. The spray guide of claim 4 wherein said cylindrical shell includes a lower rim which carries a ridge or rib which protrudes generally horizontally towards the interior of the cylindrical cap from an exterior wall. Said ridge designed to be aligned with an aerosol cap gap which exists in an aerosol can between the body of the can and the aerosol cap. Said ridge for being received within the gap maintaining the cylindrical cap and consequently the spray guide in fixed attachment with the aerosol can.

7. The spray guide of claim 4 herein said cylindrical shell includes a lower rim which carries a flexible member which protrudes generally horizontally towards the interior of the cylindrical cap from an exterior wall. Said flexible member designed to engage the surface of the body of the can maintaining the cylindrical cap and consequently the spray guide in fixed attachment with the aerosol can.

8. The spray guide of claim 4 wherein said aerosol cap mount is circumferentially contiguous for enclosing the actuator of the aerosol spray can and providing a three hundred and sixty degree surface for fixedly attaching to the aerosol spray can or cap.

9. The spray guide of claim 1 wherein said spray guide director flares outward from said proximate end to said distal end in a manner to enable the aerosol spray to flare outward to a width at said distal end greater than the width dispensed at said nozzle for subsequent dispensing at the distal exit.

10. An aerosol spray guide for an insecticide repellant dispensed from an aerosol can having an interior housing said insecticide repellant and an actuator having an opening for dispensing said insecticide repellant from said interior housing when actuated, the aerosol can having an aerosol cap carrying the actuator, said aerosol spray guide comprising:
an aerosol cap mount having an aerosol cap mount interior for receiving an aerosol cap;
said aerosol cap mount adapted for fixedly attachment to the aerosol can or cap such that said aerosol cap mount may be securely affixed to the aerosol can wherein maneuverability of the aerosol can results in movement of said aerosol cap mount;
said aerosol cap mount defining an aerosol actuator opening permitting access to the actuator from an individual;
a spray guide director defining an aerosol passageway extending from a proximal end carried by said aerosol cap mount and a distal end oppositely dispose from said aerosol cap mount;
said proximal end defining a spray guide entrance way for receiving an aerosol dispensed from said aerosol can and said distal end defining a spray guide exit having a predetermined circumference for dispensing the aerosol away from the spray guide director;
said spray guide director directing the flow of the dispensed aerosol from the spray guide entrance way to said spray guide exit for directing the aerosol to a target located within the circumferential profile of the spray guide exit;
said spray guide director being maneuverable by movement of the aerosol dispenser,
said aerosol cap mount includes a left and right side of a general height which is taller than the height of the aerosol cap when the aerosol cap is received within the aerosol cap mount;
said aerosol cap mount includes a lower rim defining an aerosol cap opening enabling an aerosol cap to be inserted from beneath the aerosol cap mount into the aerosol cap mount interior;
said aerosol cap mount includes a cylindrical cap mating portion which includes a cylindrical shell forming a hollow cylindrical interior for receiving a cylindrical aerosol cap; said cylindrical shell being designed to snap over a cap of an aerosol can and encircle the cap by receiving the cylindrical cap in the interior of the cylindrical shell;
said cylindrical shell includes a lower rim which carries a flexible member which protrudes generally horizontally towards the interior of the cylindrical cap from an exterior wall. Said flexible member designed to engage the surface of the body of the can maintaining the cylindrical cap and consequently the spray guide in fixed attachment with the aerosol can.

11. The spray guide of claim 10 wherein said aerosol cap mount is circumferentially contiguous for enclosing the actuator of the aerosol spray can and providing a three hundred and sixty degree surface for fixedly attaching to the aerosol spray can or cap.

12. The spray guide of claim 10 wherein said spray guide director flares outward from said proximate end to said distal end in a manner to enable the aerosol spray to flare outward to a width at said distal end greater than the width dispensed at said nozzle for subsequent dispensing at the distal exit.

13. The spray guide of claim 10 wherein said spray guide director and said aerosol cap mount are an integral piece made from rigid plastic wherein movement of the aerosol can results in corresponding movement of the exit passageway of the spray guide director enabling the dispensed aerosol to be targeted to a specific insect positioned within the circumferential profile of the spray guide director.

14. A method of killing an insect, said method comprising:
providing an aerosol can housing an insecticide, said aerosol can having an actuator enabling the dispensing of insecticide from the interior of the aerosol can and an aerosol cap;
providing an aerosol spray guide comprising:
an aerosol cap mount having an aerosol cap mount interior for receiving an aerosol cap;
said aerosol cap mount adapted for fixedly attachment to the aerosol can or cap such that said aerosol cap mount may be securely affixed to the aerosol can or cap wherein maneuverability of the aerosol can result in movement of said aerosol cap mount;
said aerosol cap mount defining an aerosol actuator opening permitting access to the actuator from an individual;
a spray guide director defining an aerosol passageway extending from a proximal end carried by said aerosol cap mount and a distal end oppositely disposed from said aerosol cap mount;
said proximal end defining a spray guide entrance way for receiving an aerosol dispensed from said aerosol can and said distal end defining a spray guide exit having a predetermined circumference for dispensing the aerosol away from the spray guide director;
said spray guide director directing the flow of the dispensed aerosol from the spray guide entrance way to said spray guide exit for directing the aerosol to a target located within the circumferential profile of the spray guide exit;
said spray guide director being maneuverable by movement of the aerosol dispenser;
positioning the spray guide director such that an insect is positioned within the circumferential profile of the spray guide exit; and
actuating the aerosol actuator for dispensing an insecticide from said aerosol can through said spray guide director and exiting the spray guide exit.

15. The method of claim 14 further including positioning the spray guide director onto a surface when an insect is located on said surface wherein the circumferential profile of said spray guide exit is in contiguous contact with said surface enclosing the insect within said profile such that insecticide dispensed from said aerosol can is contained within said circumferential profile of said spray guide exit.

16. The method of claim 15 wherein said surface is a wall, a ceiling or a floor.
